(19) United States
(12) Patent Application Publication
(10) Pub. No.: US 2022/0188000 A1
(43) Pub. Date: Jun. 16, 2022

(54) SHARED DATA BUFFER FOR PREFETCH AND NON-PREFETCH ENTRIES

(71) Applicant: Intel Corporation, Santa Clara, CA (US)

(72) Inventors: Nishant Singh, Bengaluru (IN); Sharada Venkateswaran, San Francisco, CA (US); Daniel Liu, Santa Clara, CA (US)

(73) Assignee: Intel Corporation, Santa Clara, CA (US)

(21) Appl. No.: 17/688,611

(22) Filed: Mar. 7, 2022

(51) Int. Cl. G06F 3/06

(52) U.S. Cl. CPC G06F 3/0631; G06F 3/0656; G06F 3/0679; G06F 3/0611; G06F 3/0659

(57) ABSTRACT

An embodiment of an apparatus may comprise one or more substrates and a controller coupled to the one or more substrates, the controller including a read data buffer, a content-addressable memory, and circuitry to track both prefetch read requests and non-prefetch read requests for a memory with the content-addressable memory and to store both prefetch entries and non-prefetch entries in the read data buffer. Other embodiments are disclosed and claimed.

### BACKGROUND

In reference to computer technology, prefetching generally relates to techniques that begin a fetch operation for information that is expected to be needed in the future but before the information is known to be needed. With a prefetch operation, there is generally a risk that the information is not used and the time/resources utilized by the prefetch operation is wasted. Memory prefetching refers to fetching data from a current memory location to a local memory before the data is actually needed. A computer processor generally includes fast and local cache memory in which prefetched data is held until the data is required or discarded. Some processors include hardware prefetchers that prefetch data and instructions that are likely to be required in the near future from main memory into a level 2 (L2) cache. Ideally, the hardware prefetchers reduce the latency associated with memory reads.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a block diagram of an example of an electronic system according to an embodiment;

FIG. 2 is a block diagram of an example of an electronic apparatus according to an embodiment;

FIG. 3 is a flowchart of an example of a method according to an embodiment;

FIG. 4 is a block diagram of an example of a memory system according to an embodiment;

FIGS. 5 to 8 are illustrative sequence diagrams according to embodiments; and

FIG. 9 is a block diagram of an example of a computing system according to an embodiment.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smartphones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, Field Programmable Gate Array (FPGA), firmware, driver, software, or any combination thereof. The material disclosed herein may also be implemented as instructions stored on a machine-readable medium, which may be read and executed by Moore Machine, Mealy Machine, and/or one or more processors. A machine-readable medium may include any medium and/or mechanism for storing or transmitting information in a form readable by a machine (e.g., a computing device). For example, a machine-readable medium may include read only memory (ROM); random access memory (RAM); Dynamic random-access memory (DRAM), magnetic disk storage media; optical storage media; NV memory devices; phase-change memory, qubit solid-state quantum memory, electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every embodiment may not necessarily include the particular feature, structure, or characteristic. Moreover, such phrases are not necessarily referring to the same implementation. Further, when a particular feature, structure, or characteristic is described in connection with an embodiment, it is submitted that it is within the knowledge of one skilled in the art to effect such feature, structure, or characteristic in connection with other implementations whether or not explicitly described herein.

Various embodiments described herein may include a memory component and/or an interface to a memory component. Such memory components may include volatile and/or nonvolatile (NV) memory. Volatile memory may be a storage medium that requires power to maintain the state of data stored by the medium. NV memory (NVM) may be a storage medium that does not require power to maintain the state of data stored by the medium. In one embodiment, the memory component may include a three dimensional (3D) crosspoint memory device, or other byte addressable write-in-place nonvolatile memory devices. In one embodiment, the memory device may be or may include memory devices that use chalcogenide glass, single or multi-level Phase Change Memory (PCM), a resistive memory, nanowire memory, ferroelectric transistor RAM (FeTRAM), anti-ferroelectric memory, magnetoresistive RAM (MRAM) memory that incorporates memristor technology, resistive memory including the metal oxide base, the oxygen vacancy base and the conductive bridge RAM (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product. In particular embodiments, a memory component with non-volatile memory may comply with one or more standards promulgated by the JEDEC, or other suitable standard (the JEDEC standards cited herein are available at jedec.org).

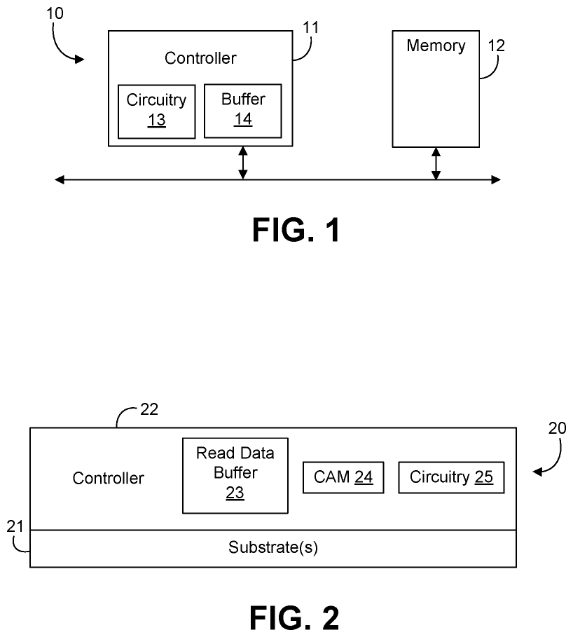

With reference to FIG. 1, an embodiment of an electronic system 10 may include a controller 11 communicatively coupled to memory 12. The controller 11 may include circuitry 13 and a buffer 14. The circuitry 13 may be configured to track both prefetch read requests and non-prefetch read requests for the memory 12, and to store both prefetch entries and non-prefetch entries in the buffer 14. In some embodiments, the circuitry 13 may be further configured to allocate prefetch entries in the buffer 14 based on a bandwidth of a workload. For example, the circuitry 13 may be configured to hold prefetch entries in the buffer 14 as long as the bandwidth of the workload is determined to not exceed a bandwidth threshold and an amount of free space for the buffer 14 is determined to exceed a space threshold for buffer space for non-prefetch entries (e.g., there is sufficient space in the buffer 14 for subsequent non-prefetch data returns).

In some embodiments, the circuitry 13 may be further configured to determine the bandwidth of the workload based on a first threshold for an occupancy of the buffer 14 and a second threshold for outstanding memory requests. In some embodiments, the circuitry 13 may also be configured to deallocate prefetch entries from the buffer 14 if the bandwidth of the workload is determined to exceed a bandwidth threshold. For example, the circuitry 13 may be configured to deallocate prefetch entries from the buffer 14 a predetermined amount of time after the bandwidth of the workload is determined to exceed the bandwidth threshold (e.g., the predetermined amount of time may be zero to immediately deallocate the prefetch entries or may correspond to a desired amount of time to provide a base line extension of merge windows). In some embodiments, the circuitry 13 may be further configured to store both prefetch request tracker entries and non-prefetch request tracker entries in a content-addressable memory (CAM).

Embodiments of the controller 11 may include a general purpose controller, a special purpose controller, a memory controller, a storage controller, a micro-controller, an execution unit, etc. In some embodiments, the memory 12, the circuitry 13, the buffer 14, and/or other system memory may be located in, or co-located with, various components, including the controller 11 (e.g., on a same die or package substrate). For example, the controller 11 may be configured as a memory controller and the memory 12 may be a connected memory device such as NV dual-inline memory module (NVDIMM), a solid-state drive (SSD), a storage node, etc. Embodiments of each of the above controller 11, memory 12, circuitry 13, buffer 14, and other system components may be implemented in hardware, software, or any suitable combination thereof. For example, hardware implementations may include configurable logic, fixed-functionality logic, or any combination thereof. Examples of configurable logic include suitably configured programmable logic arrays (PLAs), FPGAs, complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Alternatively, or additionally, all or portions of these components may be implemented in one or more modules as a set of logic instructions stored in a machine- or computer-readable storage medium such as RAM, ROM, programmable ROM (PROM), firmware, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C#, VHDL, Verilog, System C or the like and conventional procedural programming languages, such as the “C” programming language or similar programming languages. For example, the memory 12, persistent storage media, or other system memory may store a set of instructions (e.g., which may be firmware instructions) which when executed by the controller 11 cause the system 10 to implement one or more components, features, or aspects of the system 10 (e.g., controlling access to the memory 12, tracking both prefetch read requests and non-prefetch read requests for the memory 12, storing both prefetch entries and non-prefetch entries in the buffer 14, etc.).

With reference to FIG. 2, an embodiment of an electronic apparatus 20 may include one or more substrates 21, and a controller 22 coupled to the one or more substrates 21. The controller 22 may include a read data buffer 23, a CAM 24, and circuitry 25 to track both prefetch read requests and non-prefetch read requests for a memory with the CAM 24 and to store both prefetch entries and non-prefetch entries in the read data buffer 23. In some embodiments, the circuitry 25 may be further configured to allocate prefetch entries in the read data buffer 23 based on a bandwidth of a workload. For example, the circuitry 25 may be configured to hold prefetch entries in the read data buffer 23 as long as a bandwidth of the workload is determined to not exceed a bandwidth threshold and an amount of free space for the read data buffer 23 is determined to exceed a space threshold for buffer space for non-prefetch entries.

In some embodiments, the circuitry 25 may be further configured to determine the bandwidth of the workload based on a first threshold for an occupancy of the read data buffer 23 and a second threshold for outstanding memory requests. In some embodiments, the circuitry 25 may also be configured to deallocate prefetch entries from the read data buffer 23 if the bandwidth of the workload is determined to exceed a bandwidth threshold. For example, the circuitry 25 may be configured to deallocate prefetch entries from the read data buffer 23 a predetermined amount of time after the bandwidth of the workload is determined to exceed the bandwidth threshold.

For example, the controller 22 may be configured as a memory controller. For example, the memory may be a connected memory device (e.g., NVDIMM, a SSD, a storage node, etc.).

Embodiments of the circuitry 25 may be implemented in a system, apparatus, computer, device, etc., for example, such as those described herein. More particularly, hardware implementations may include configurable logic (e.g., suitably configured PLAs, FPGAs, CPLDs, general purpose microprocessors, etc.), fixed-functionality logic (e.g., suitably configured ASICs, combinational logic circuits, sequential logic circuits, etc.), or any combination thereof. Alternatively, or additionally, the circuitry 25 may be implemented in one or more modules as a set of logic instructions stored in a machine- or computer-readable storage medium such as RAM, ROM, PROM, firmware, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C#, VHDL, Verilog, System C or the like and conventional procedural programming languages, such as the “C” programming language or similar programming languages.

For example, the circuitry 25 may be implemented on a semiconductor apparatus, which may include the one or more substrates 21, with the circuitry 25 coupled to the one or more substrates 21. In some embodiments, the circuitry 25 may be at least partly implemented in one or more of configurable logic and fixed-functionality hardware logic on semiconductor substrate(s) (e.g., silicon, sapphire, gallium-arsenide, etc.). For example, the circuitry 25 may include a transistor array and/or other integrated circuit components coupled to the substrate(s) 21 with transistor channel regions that are positioned within the substrate(s) 21. The interface between the circuitry 25 and the substrate(s) 21 may not be an abrupt junction. The circuitry 25 may also be considered to include an epitaxial layer that is grown on an initial wafer of the substrate(s) 21.

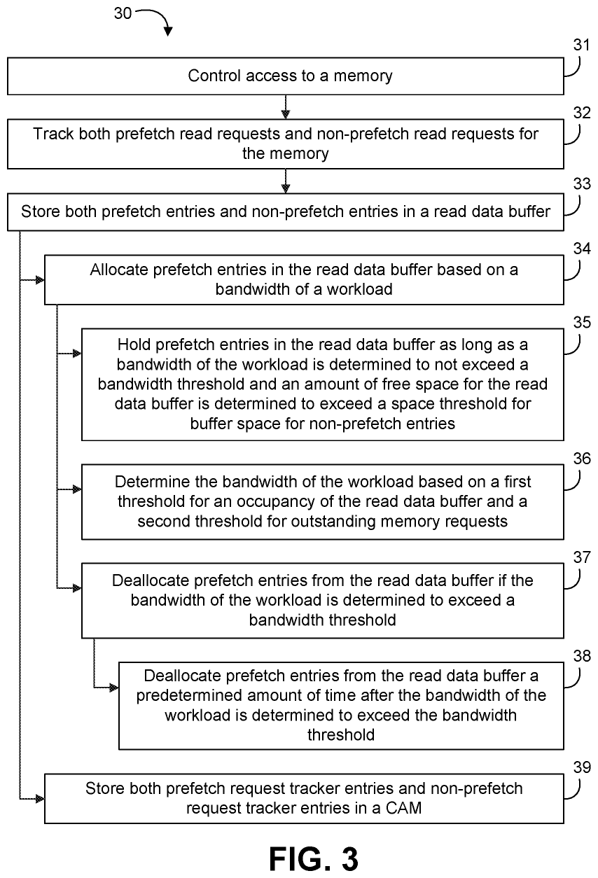

Turning now to FIG. 3, an embodiment of a method 30 may include controlling access to a memory at block 31, tracking both prefetch read requests and non-prefetch read requests for the memory at block 32, and storing both prefetch entries and non-prefetch entries in a read data buffer at block 33. Some embodiments of the method 30 may further include allocating prefetch entries in the read data buffer based on a bandwidth of a workload at block 34. For example, the method 30 may also include holding prefetch entries in the read data buffer as long as a bandwidth of the workload is determined to not exceed a bandwidth threshold and an amount of free space for the read data buffer is determined to exceed a space threshold for buffer space for non-prefetch entries at block 35.

In some embodiments, the method 30 may further include determining the bandwidth of the workload based on a first threshold for an occupancy of the read data buffer and a second threshold for outstanding memory requests at block 36. Some embodiments of the method 30 may also include deallocating prefetch entries from the read data buffer if the bandwidth of the workload is determined to exceed a bandwidth threshold at block 37. For example, the method 30 may further include deallocating prefetch entries from the read data buffer a predetermined amount of time after the bandwidth of the workload is determined to exceed the bandwidth threshold at block 38. In some embodiments, the method 30 may also include storing both prefetch request tracker entries and non-prefetch request tracker entries in a CAM at block 39.

Embodiments of the method 30 may be implemented in a system, apparatus, computer, device, etc., for example, such as those described herein. More particularly, hardware implementations may include configurable logic (e.g., suitably configured PLAs, FPGAs, CPLDs, general purpose microprocessors, etc.), fixed-functionality logic (e.g., suitably configured ASICs, combinational logic circuits, sequential logic circuits, etc.), or any combination thereof. Hybrid hardware implementations include static dynamic System-on-Chip (SoC) re-configurable devices such that control flow, and data paths implement logic for the functionality. Alternatively, or additionally, the method 30 may be implemented in one or more modules as a set of logic instructions stored in a machine- or computer-readable storage medium such as RAM, ROM, PROM, firmware, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C#, VHDL, Verilog, System C or the like and conventional procedural programming languages, such as the “C” programming language or similar programming languages.

For example, the method 30 may be implemented on a computer readable medium. Embodiments or portions of the method 30 may be implemented in firmware, applications (e.g., through an application programming interface (API)), or driver software running on an OS. Additionally, logic instructions might include assembler instructions, instruction set architecture (ISA) instructions, data set architecture (DSA) commands, (machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, Moore Machine, Mealy Machine, etc.).

Some embodiments may advantageously provide technology for programmable prefetch data retention with efficient buffer reuse for reduced memory access latency. Extended prefetch tables (XPT) memory prefetch refers to a feature where early, speculative reads initiate an early memory fetch. Prefetching is an important technique to improve memory performance by reducing access latencies. However, for effective prefetching, the prefetched data needs to be held until the demand read request is received. The window during which a demand read merges with a prefetch and gets to use the prefetched data may be referred to as a merge window. To achieve a high merge rate and improve the efficiency of prefetching, a conventional memory controller may utilize a large prefetch cache. A problem is that implementation of such a cache may be complex and area intensive.

A conventional technique to improve prefetch efficiency may require that the demand read be received before the data for the prefetch is returned from memory. Accordingly, the merge window is constrained and this severely limits prefetch efficiency. Holding on to the prefetched data in a side data cache may increase the merge rate. When a “last-level cache (LLC) cache miss read” or demand read is received, in addition to the outstanding requests to memory, a memory controller may look up the prefetch data cache and potentially merge with prefetched data in the cache thus allowing a longer merge window. A problem is that, depending on the number of cache lines to store, a side data catch for prefetched data may be very large. For example, a data cache may require storing 64 bytes of data per entry, in addition to metadata bits, per cache line.

Another problem is overhead associated with handling of cache entries. As the prefetch data gets installed in the prefetch cache, its original transaction retires. Accordingly, the memory/cache controller may need to: 1) store the address (e.g., and/or any other information that is required to allow merge such us metadata, security key or other secure indication(s), etc.) per cache line to allow for incoming entries to merge into the cache; and 2) manage the validity of the data in the cache (e.g., because subsequent writes, or “reads that spawn writes” (e.g., directory updates), may also hit in the cache). Such validity management may be in addition to management of cache replacement policies. As previously, the address/metadata storage may be very large (e.g., area intensive and costly). The address storage may be over and above transaction address storage, which may require a separate address CAM.

Another problem is inefficient use of data buffer entries. At higher buffer occupancies, the prefetch itself may be held back yielding little or no latency benefits on merge. Accordingly, prefetch technology may work better for a memory controller (e.g., or a common memory interface (CMI) responder) buffer occupancy that is low to medium. In a CMI requestor implementation, a shared data buffer may be sized for maximum bandwidth. In the context of prefetch at low-medium bandwidth workloads, however, the shared data buffer has entries to spare.

Some embodiments may overcome one or more of the foregoing problems. In some embodiments, spare entries of a shared data buffer may be used to hold prefetch data rather than leaving the shared buffer unoccupied. Advantageously, some embodiments may make more efficient use of a shared data buffer and may avoid the need for a separate prefetch cache (e.g., or may enable the use of a smaller prefetch cache).

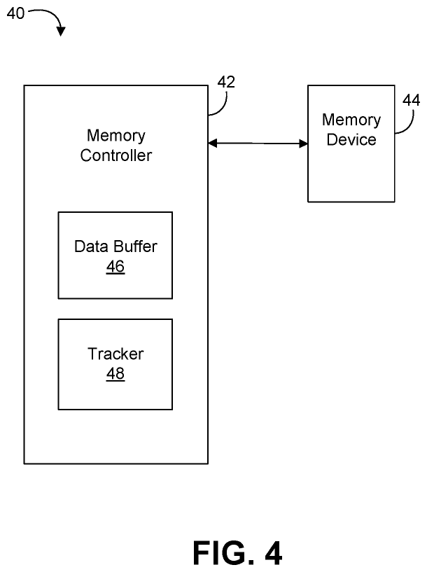

With reference to FIG. 4, an embodiment of a memory system 40 may include a memory controller 42 communicatively coupled to a memory device 44. The memory controller 42 may include a data buffer 46 and a tracker 48. Some embodiments may provide technology for the data buffer 46 to be shared and utilized as a prefetch cache (e.g., in addition to non-prefetch utilization of the data buffer 46). Advantageously, some embodiments may improve a merge rate and lead to better latency savings. Some embodiments may provide effective prefetching and may further eliminate the complexity and/or the area/power cost of a separate prefetch cache implementation.

Instead of using a separate, dedicated cache, some embodiments may share the data buffer 46 and tracker 48 for all reads (including prefetch) to hold the data longer. After a prefetch data entry is returned from the memory device 44 to the shared data buffer 46, some embodiments may monitor the occupancy of the shared data buffer 46 and the outstanding memory requests for the memory device 44. If the monitored occupancy and/or the monitored memory requests indicate a high bandwidth workload, some embodiments may deallocate the prefetched data entry from the shared data buffer 46 immediately or based on a fixed timer (e.g., to get some base line extension of merge windows).

If a low-medium workload is identified based on the monitored information (e.g., where the identified workload may be a better target for prefetch), some embodiments may hold on to the prefetched data entry indefinitely, until the shared data buffer 46 starts running out of buffer space for subsequent data returns. Some embodiments may set a free space threshold that allows a certain number of prefetch data returns to be held, advantageously allowing a longer window for potential demand requests to merge with the prefetch data. Some embodiments may also provide technology to hold on to a corresponding prefetch tracker entry in the tracker 48. Holding on to the prefetch tracker entry enables the same address-based CAM on the tracker 48 to be utilized for both non-prefetch requests and for merge or invalidation of prefetches (e.g., for ordering requirements).

Advantageously, some embodiments may provide an extended window of prefetch merge, a higher merge rate, and/or better non-idle latency. By allowing the data buffer entry to be held longer, some embodiments may extend the merge window to be greater than the memory roundtrip. Also, by providing a threshold on the number of prefetch tracker and buffer entries, some embodiments may allow “non-prefetch” entries to be not impacted by the held up prefetch entries. Some embodiments may provide technology for programmability of one or more of the thresholds and/or other parameters described herein (e.g., via basic input/output system (BIOS) settings, unified extensible firmware interface (UEFI) settings, configuration registers, etc.). Advantageously, by tuning the window and/or threshold(s), some embodiments, may provide a better hit/merge rate that may lead to an overall non-idle latency improvement.

Another advantage is that some embodiments may not require any separate structure for prefetch data or prefetch requests. Some embodiments may utilize a shared request tracker and a shared read data buffer for both prefetch data/requests and non-prefetch data/requests. By not relying on a separate prefetch cache or any additional prefetch address/attribute tracking structure, some embodiments advantageously remove the area overhead of the separate prefetch cache as well as the added cost to the die size. Some embodiments may remove the need for a separate address CAM on the separate prefetch cache, and any associated logic overhead on managing the validity of the data and merging incoming entries into the separate prefetch cache.

Advantageously, some embodiments provide improved efficiency with the shared read data buffer reuse because the shared read data buffer may be sized to sustain maximum memory bandwidth. Accordingly, the shared read data buffer may have otherwise unused capacity for low-medium bandwidth workloads. Prefetches may be architected to be throttled at the source if buffer occupancies are high, and embodiments may make efficient use of the otherwise unused capacity of the shared read data buffer for prefetches for low-medium bandwidth workloads.

Common Memory Interface (CMI) Examples

An embodiment of a CMI requestor includes a read completion/read data buffer (e.g., also referred to below as a common data buffer) and a request tracker. The common data buffer is credited to a CMI responder, and the request tracker tracks read and/or write requests sent to the CMI responder with a transaction identifier (TID). Embodiments of a CMI requestor may further support XPT prefetch and an address-based CAM on the request tracker, such that that an incoming demand read can CAM into the request tracker and merge into an existing prefetch.

In temporal or spatial prefetchers, where prefetch data consumption is not time bound, a cache may be required which can indefinitely hold the data. XPT prefetch, however, may be primarily directed to latency improvement where the feature architecture (e.g., via heuristics and tuning) ensures that an eventual read will miss in cache and a demand read will merge into the prefetch. Non-merging prefetches are wasteful. Accordingly, the merge window is time bound and there is no requirement to hold the data indefinitely (e.g., a cache is not necessary).

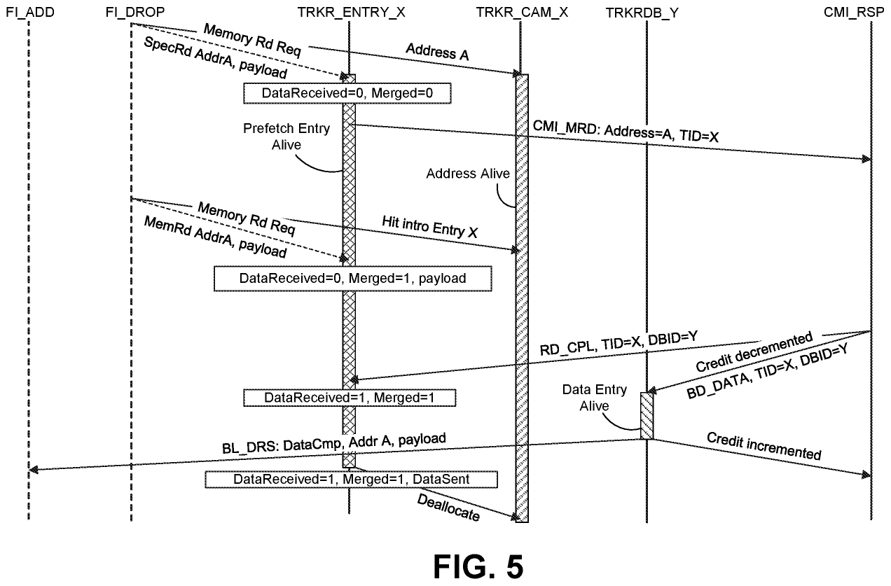

With reference to FIGS. 5 to 8, illustrative sequence diagrams show examples of read merges and prefetches in accordance with embodiments. FI_ADD and FI_DROP denote nominal fabric interfaces upstream of a CMI requestor. TRKR_ENTRY_X denotes a prefetch entry with a transaction identifier (TID) of X in the tracker. TRKR_CAM_X denotes an address A in the CAM associated with the prefetch entry X. TRKRDB_Y indicates an entry in the common data buffer with a data buffer identifier (DBID) of Y. TRKR_ENTRY_Y denotes a prefetch entry with a tracker identifier (TID) of Y in the tracker. CMI_RSP denotes a CMI responder. SpecRd denotes a speculative read. MemRd denotes a non-speculative read. CMI_MRD denotes a memory read. RD_CPL denotes a read completion. BD_DATA denotes a data write. BL_DRS denotes a data response. DataCmp denotes a data completion.

With reference to FIG. 5, an illustrative sequence diagram shows an example of a new read merging into a prefetch entry X and using DBID Y. For an example incoming memory prefetch, the CMI requestor sends a memory read transaction, similar to any other read, with a unique TID (e.g., TID=X). The CMI responder uses a credit into the common data buffer to respond back. Note that for a pre-allocated implementation the common data buffer may be as big as the TID space and hence crediting might not be required. For most implementations, however, a credited data buffer is utilized, because the request tracker may be bigger than the data buffer requirements and a pre-allocated data buffer may be too large.

On the read completion, the CMI requestor allocates a new data buffer entry (e.g., entry Y) and couples the entry Y to the tracker entry X. If the prefetch has already been “merged into,” then data will go out as illustrated in FIG. 5. The data buffer is deallocated after the data response goes out. Also, the coupled tracker entry and camming structure is deallocated after the transaction completes.

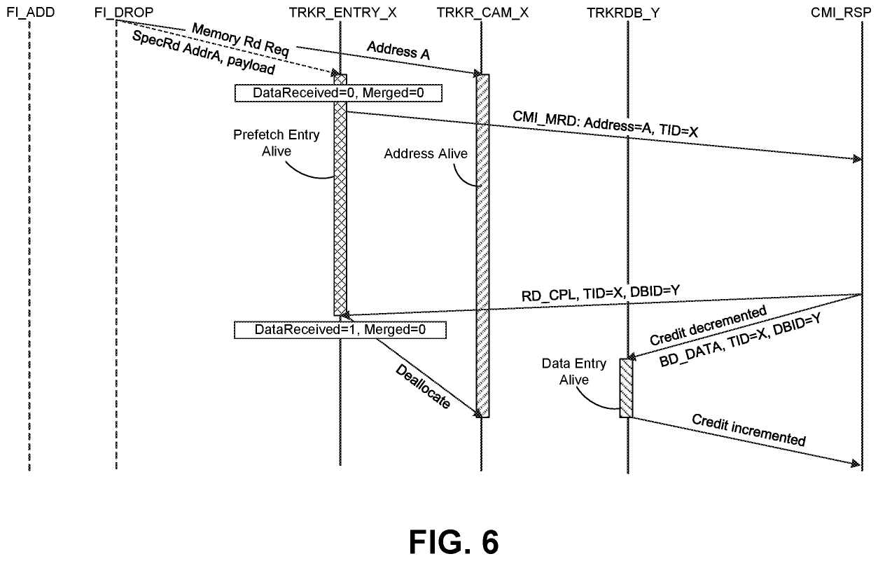

With reference to FIG. 6, an illustrative sequence diagram shows an example of no read merging into prefetch entry X. For example, embodiments may allow enabling/disabling various features. With some features disabled, if the prefetch entry is not merged by the time the read completion comes back, the data is dropped and the prefetch entry X and buffer entry Y is deallocated (e.g., similar to operation with a separate prefetch cache). A time limited deallocation of the prefetch entry and buffer entry limits the merge window to a read completion turnaround time. As turnaround times decrease, a memory read merge window may be negatively impacted. Also depending on a CMI responder implementation, reads may sometimes hit into inflight write data buffers and return data directly from the buffer, which further reduces the read data turnaround time.

Some embodiments may not utilize a separate prefetch cache, advantageously saving cost and silicon area, making more efficient use of a read data buffer, and allowing the prefetch data to be held longer. As noted above, demand read to prefetch delay is not arbitrary because heuristics guarantee that prefetch is always followed by demand reads in a time bound manner (e.g., a cache is not needed to hold the data indefinitely). Some embodiments may target prefetch for low-medium bandwidth workloads, advantageously making efficient use of otherwise unused space in the read data buffer. Some embodiments may utilize a credited data buffer technique together with additional techniques to delay the deallocation of the prefetch entries and/or data buffer entries.

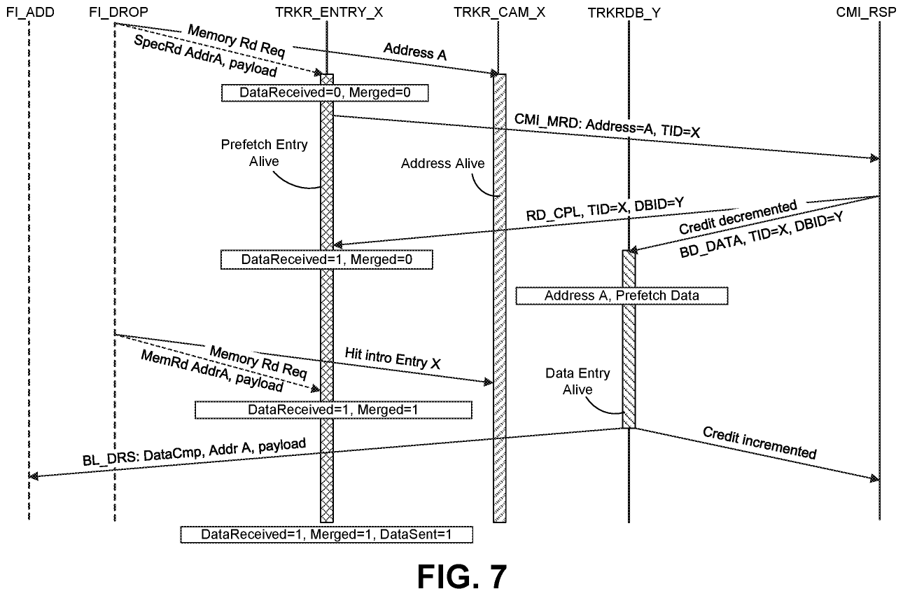

With reference to FIG. 7, an illustrative sequence diagram shows an example of a read merge according to an embodiment. As shown in FIG. 7, if read completion comes back and entry X has not yet been “merged into” (e.g., Merged=0), data buffer entry Y is still allocated. When a new read merges into entry X and as data received=1, the data buffer entry (e.g., DBID=Y) may be used for the data response. For example, when a “non-prefetch” read comes in and merges into entry X, a fresh request is not issued to the controller (e.g., the CMI responder) and instead the data is sent out from buffer entry Y. At that point the data response sent out eventually deallocates the data buffer entry Y and the associated coupled prefetch entry X.

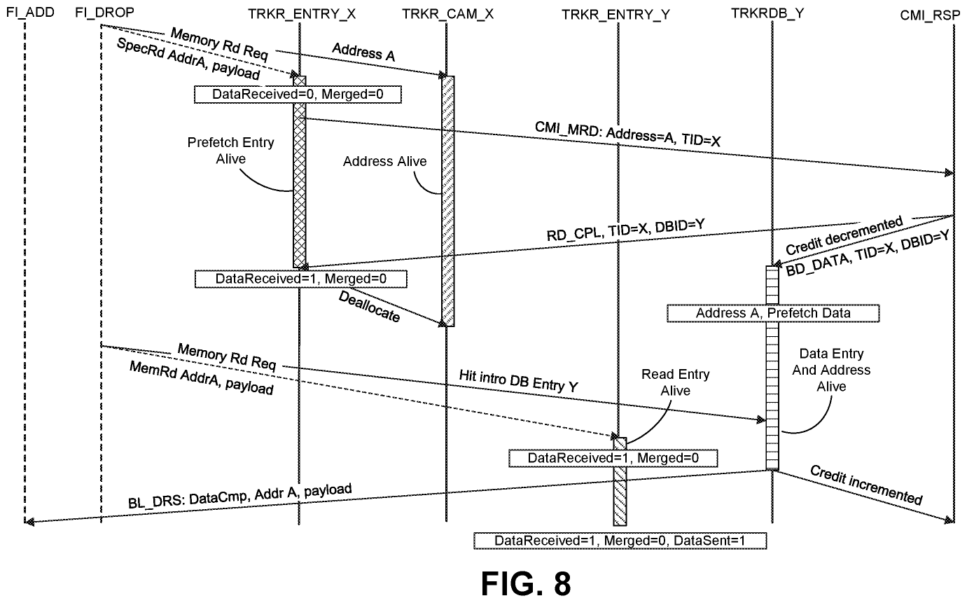

With reference to FIG. 8, an illustrative sequence diagram shows an example of how the data buffer entry Y may be decoupled from the tracker entry X. As the prefetch tracker entry X is not needed, some embodiments may decouple the buffer entry Y from the prefetch tracker entry X and allow early deallocation of the prefetch entry X. For example, embodiments may implement a separate address CAM on the data buffer entries, and the CAM on tracker entries may not be reused. As shown in FIG. 8, a new read merges into DBID Y and uses a new tracker entry Y. When data received is marked as 1, DBID Y is used to send the data out.

Example Buffer Deallocation Policies

Because the common data buffer is not a cache, the buffer entries cannot be held indefinitely. Eventually a buffer entry is deallocated and a credit is refunded to the responder. Examples of when the data buffer entry “Y” and/or the associated prefetch tracker “X” may be retired include the following conditions: 1) Merge and deallocate: If the entry X is merged into, then data is sent from buffer entry Y; Y is deallocated thereafter; 2) Invalidate and deallocate: If the address (either in prefetch entry X or data buffer Y CAM) is invalidated, due to an invalidating read or write, then X and Y are deallocated thereafter; Tracker CAMing and a prefetch data ordering requirement cover the scenario where the prefetch tracker is coupled with the buffer entry (e.g., as shown in FIG. 7); The deallocation of Y may be implemented via the data buffer address CAM if the data buffer entry Y is decoupled from the entry X (e.g., as shown in FIG. 8); 3) Time bound deallocate: If entry X/buffer entry Y is not merged and a timer expires, then entry X/buffer entry Y are deallocated thereafter. In some embodiments, the timer may be configurable via a configuration status register (CSR); A suitably configured timer may extend the time the entries are held while ensuring that unused data entries are not holding up shared buffer credits from the responder; and/or 4) Threshold based deallocation: Examples include: a. Monitor prefetch data buffer entries: A threshold number of prefetch buffer entries is breached and a new prefetch data comes back; Entries may be replaced based on an oldest timer value associated with the entries; and/or b. Monitor overall buffer occupancy and request proxy: instead of a timer, overall occupancy of the common data buffer (prefetch and non-prefetch) is monitored; If the overall occupancy breaches a threshold, deallocate a new coming prefetch data entry immediately; Otherwise, keep the entry around until the threshold is breached; The entries may be held indefinitely if the common data buffer operates at a low-medium bandwidth workload.

The technology discussed herein may be provided in various computing systems (e.g., including a non-mobile computing device such as a desktop, workstation, server, rack system, etc., a mobile computing device such as a smartphone, tablet, Ultra-Mobile Personal Computer (UMPC), laptop computer, ULTRABOOK computing device, smart watch, smart glasses, smart bracelet, etc., and/or a client/edge device such as an Internet-of-Things (IoT) device (e.g., a sensor, a camera, etc.)).

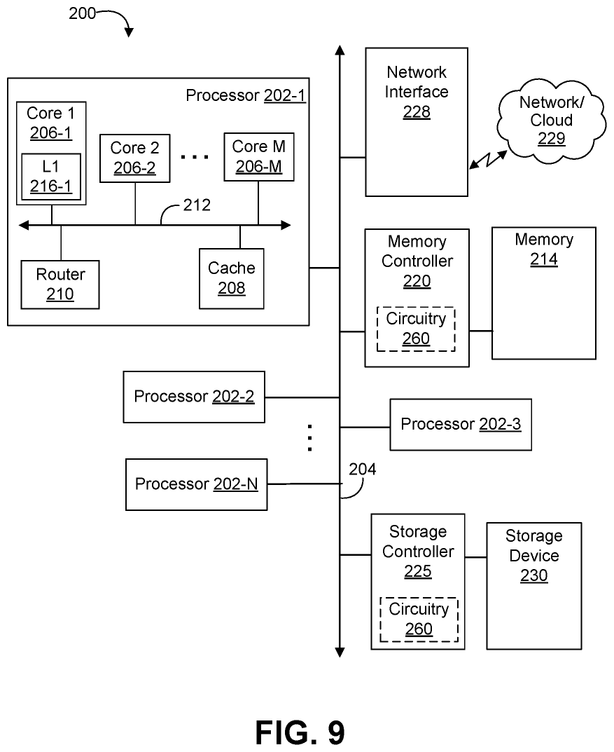

Turning now to FIG. 9, an embodiment of a computing system 200 may include one or more processors 202-1 through 202-N (generally referred to herein as “processors 202” or “processor 202”). The processors 202 may communicate via an interconnection or bus 204. Each processor 202 may include various components some of which are only discussed with reference to processor 202-1 for clarity. Accordingly, each of the remaining processors 202-2 through 202-N may include the same or similar components discussed with reference to the processor 202-1.

In some embodiments, the processor 202-1 may include one or more processor cores 206-1 through 206-M (referred to herein as “cores 206,” or more generally as “core 206”), a cache 208 (which may be a shared cache or a private cache in various embodiments), and/or a router 210. The processor cores 206 may be implemented on a single integrated circuit (IC) chip. Moreover, the chip may include one or more shared and/or private caches (such as cache 208), buses or interconnections (such as a bus or interconnection 212), memory controllers, or other components.

In some embodiments, the router 210 may be used to communicate between various components of the processor 202-1 and/or system 200. Moreover, the processor 202-1 may include more than one router 210. Furthermore, the multitude of routers 210 may be in communication to enable data routing between various components inside or outside of the processor 202-1.

The cache 208 may store data (e.g., including instructions) that is utilized by one or more components of the processor 202-1, such as the cores 206. For example, the cache 208 may locally cache data stored in a memory 214 for faster access by the components of the processor 202. As shown in FIG. 9, the memory 214 may be in communication with the processors 202 via the interconnection 204. In some embodiments, the cache 208 (that may be shared) may have various levels, for example, the cache 208 may be a mid-level cache and/or a last-level cache (LLC). Also, each of the cores 206 may include a level 1 (L1) cache (216-1) (generally referred to herein as “L1 cache 216”). Various components of the processor 202-1 may communicate with the cache 208 directly, through a bus (e.g., the bus 212), and/or a memory controller or hub.

As shown in FIG. 9, memory 214 may be coupled to other components of system 200 through a memory controller 220. Memory 214 may include volatile memory and may be interchangeably referred to as main memory or system memory. Even though the memory controller 220 is shown to be coupled between the interconnection 204 and the memory 214, the memory controller 220 may be located elsewhere in system 200. For example, memory controller 220 or portions of it may be provided within one of the processors 202 in some embodiments. Alternatively, memory 214 may include byte-addressable non-volatile memory such as INTEL OPTANE technology.

The system 200 may communicate with other devices/systems/networks via a network interface 228 (e.g., which is in communication with a computer network and/or the cloud 229 via a wired or wireless interface). For example, the network interface 228 may include an antenna (not shown) to wirelessly (e.g., via an Institute of Electrical and Electronics Engineers (IEEE) 802.11 interface (including IEEE 802.11a/b/g/n/ac, etc.), cellular interface, 3G, 4G, LTE, BLUETOOTH, etc.) communicate with the network/cloud 229.

System 200 may also include a storage device such as a storage device 230 coupled to the interconnect 204 via storage controller 225. Hence, storage controller 225 may control access by various components of system 200 to the storage device 230. Furthermore, even though storage controller 225 is shown to be directly coupled to the interconnection 204 in FIG. 9, storage controller 225 can alternatively communicate via a storage bus/interconnect (such as the SATA (Serial Advanced Technology Attachment) bus, Peripheral Component Interconnect (PCI) (or PCI EXPRESS (PCIe) interface), NVM EXPRESS (NVMe), Serial Attached SCSI (SAS), Fiber Channel, CXL, etc.) with one or more other components of system 200 (for example where the storage bus is coupled to interconnect 204 via some other logic like a bus bridge, chipset, etc.) Additionally, storage controller 225 may be incorporated into memory controller logic or provided on a same integrated circuit (IC) device in various embodiments (e.g., on the same circuit board device as the storage device 230 or in the same enclosure as the storage device 230).

Furthermore, storage controller 225 and/or storage device 230 may be coupled to one or more sensors (not shown) to receive information (e.g., in the form of one or more bits or signals) to indicate the status of or values detected by the one or more sensors. These sensor(s) may be provided proximate to components of system 200 (or other computing systems discussed herein), including the cores 206, interconnections 204 or 212, components outside of the processor 202, storage device 230, SSD bus, SATA bus, storage controller 225, circuitry 260, etc., to sense variations in various factors affecting power/thermal behavior of the system/platform, such as temperature, operating frequency, operating voltage, power consumption, and/or inter-core communication activity, etc.

As shown in FIG. 9, features or aspects of the circuitry 260 may be distributed throughout the system 200, and/or co-located/integrated with various components of the system 200. Any aspect of the system 200 that may require or benefit from shared data buffer technology for prefetch and non-prefetch entries may include the circuitry 260. For example, the memory 214, the memory controller 220 and the storage controller 225 may each include circuitry 260, which may be in the same enclosure as the system 200 and/or fully integrated on a printed circuit board (PCB) of the system 200. For example, the circuitry 260 may be configured to implement the shared data buffer for prefetch and non-prefetch entries technology of the various embodiments. For example, the respective circuitry 260 may be configured to provide shared data buffer technology for prefetch and non-prefetch entries for the memory 214 and/or the storage device 230.

Advantageously, the circuitry 260 may include technology to implement one or more aspects of the system 10 (FIG. 1), the apparatus 20 (FIG. 2), the method 30 (FIG. 3), the memory system 40 (e.g., see FIG. 4), and/or any of the shared data buffer features discussed herein. The system 200 may include further circuitry 260 and located outside of the foregoing components.

In some embodiments, the memory 214 may be 3D crosspoint memory (e.g., INTEL OPTANE). The circuitry 260 may be configured to track both prefetch read requests and non-prefetch read requests for the memory 214, and to store both prefetch entries and non-prefetch entries in a buffer. In some embodiments, the circuitry 260 may be further configured to allocate prefetch entries in the buffer based on a bandwidth of a workload. For example, the circuitry 260 may be configured to hold prefetch entries in the buffer as long as the bandwidth of the workload is determined to not exceed a bandwidth threshold and an amount of free space for the buffer is determined to exceed a space threshold for buffer space for non-prefetch entries (e.g., there is sufficient space in the buffer for subsequent non-prefetch data returns).

In some embodiments, the circuitry 260 may be further configured to determine the bandwidth of the workload based on a first threshold for an occupancy of the buffer and a second threshold for outstanding memory requests. In some embodiments, the circuitry 260 may also be configured to deallocate prefetch entries from the buffer if the bandwidth of the workload is determined to exceed a bandwidth threshold. For example, the circuitry 260 may be configured to deallocate prefetch entries from the buffer a predetermined amount of time after the bandwidth of the workload is determined to exceed the bandwidth threshold (e.g., the predetermined amount of time may be zero to immediately deallocate the prefetch entries or may correspond to a desired amount of time to provide a base line extension of merge windows). In some embodiments, the circuitry 260 may be further configured to store both prefetch request tracker entries and non-prefetch request tracker entries in a CAM.

### ADDITIONAL NOTES AND EXAMPLES

Example 1 includes an electronic apparatus, comprising one or more substrates, and a controller coupled to the one or more substrates, the controller including a read data buffer, a content-addressable memory, and circuitry to track both prefetch read requests and non-prefetch read requests for a memory with the content-addressable memory and to store both prefetch entries and non-prefetch entries in the read data buffer.

Example 2 includes the apparatus of Example 1, wherein the circuitry is further to allocate prefetch entries in the read data buffer based on a bandwidth of a workload.

Example 3 includes the apparatus of Example 2, wherein the circuitry is further to hold prefetch entries in the read data buffer as long as a bandwidth of the workload is determined to not exceed a bandwidth threshold and an amount of free space for the read data buffer is determined to exceed a space threshold for buffer space for non-prefetch entries.

Example 4 includes the apparatus of any of Examples 2 to 3, wherein the circuitry is further to determine the bandwidth of the workload based on a first threshold for an occupancy of the read data buffer and a second threshold for outstanding memory requests.

Example 5 includes the apparatus of any of Examples 2 to 4, wherein the circuitry is further to deallocate prefetch entries from the read data buffer if the bandwidth of the workload is determined to exceed a bandwidth threshold.

Example 6 includes the apparatus of Example 5, wherein the circuitry is further to deallocate prefetch entries from the read data buffer a predetermined amount of time after the bandwidth of the workload is determined to exceed the bandwidth threshold.

Example 7 includes an electronic system, comprising memory, and a controller communicatively coupled to the memory, the controller including a buffer and circuitry to track both prefetch read requests and non-prefetch read requests for the memory, and store both prefetch entries and non-prefetch entries in the buffer.

Example 8 includes the system of Example 7, wherein the circuitry is further to allocate prefetch entries in the buffer based on a bandwidth of a workload.

Example 9 includes the system of Example 8, wherein the circuitry is further to hold prefetch entries in the buffer as long as a bandwidth of the workload is determined to not exceed a bandwidth threshold and an amount of free space for the buffer is determined to exceed a space threshold for buffer space for non-prefetch entries.

Example 10 includes the system of any of Examples 8 to 9, wherein the circuitry is further to determine the bandwidth of the workload based on a first threshold for an occupancy of the buffer and a second threshold for outstanding memory requests.

Example 11 includes the system of any of Examples 8 to 10, wherein the circuitry is further to deallocate prefetch entries from the buffer if the bandwidth of the workload is determined to exceed a bandwidth threshold.

Example 12 includes the system of Example 11, wherein the circuitry is further to deallocate prefetch entries from the buffer a predetermined amount of time after the bandwidth of the workload is determined to exceed the bandwidth threshold.

Example 13 includes the system of any of Examples 7 to 12, wherein the circuitry is further to store both prefetch request tracker entries and non-prefetch request tracker entries in a content-addressable memory.

Example 14 includes a method, comprising controlling access to a memory, tracking both prefetch read requests and non-prefetch read requests for the memory, and storing both prefetch entries and non-prefetch entries in a read data buffer.

Example 15 includes the method of Example 14, further comprising allocating prefetch entries in the read data buffer based on a bandwidth of a workload.

Example 16 includes the method of Example 15, further comprising holding prefetch entries in the read data buffer as long as a bandwidth of the workload is determined to not exceed a bandwidth threshold and an amount of free space for the read data buffer is determined to exceed a space threshold for buffer space for non-prefetch entries.

Example 17 includes the method of any of Examples 15 to 16, further comprising determining the bandwidth of the workload based on a first threshold for an occupancy of the read data buffer and a second threshold for outstanding memory requests.

Example 18 includes the method of any of Examples 15 to 17, further comprising deallocating prefetch entries from the read data buffer if the bandwidth of the workload is determined to exceed a bandwidth threshold.

Example 19 includes the method of Example 18, further comprising deallocating prefetch entries from the read data buffer a predetermined amount of time after the bandwidth of the workload is determined to exceed the bandwidth threshold.

Example 20 includes the method of any of Examples 14 to 19, further comprising storing both prefetch request tracker entries and non-prefetch request tracker entries in a content-addressable memory.

Example 21 includes at least one non-transitory one machine readable medium comprising a plurality of instructions that, in response to being executed on a computing device, cause the computing device to control access to a memory, track both prefetch read requests and non-prefetch read requests for the memory, and store both prefetch entries and non-prefetch entries in a read data buffer.

Example 22 includes the at least one non-transitory one machine readable medium of Example 21, comprising a plurality of further instructions that, in response to being executed on the computing device, cause the computing device to allocate prefetch entries in the read data buffer based on a bandwidth of a workload.

Example 23 includes the at least one non-transitory one machine readable medium of Example 22, comprising a plurality of further instructions that, in response to being executed on the computing device, cause the computing device to hold prefetch entries in the read data buffer as long as a bandwidth of the workload is determined to not exceed a bandwidth threshold and an amount of free space for the read data buffer is determined to exceed a space threshold for buffer space for non-prefetch entries.

Example 24 includes the at least one non-transitory one machine readable medium of any of Examples 22 to 23, comprising a plurality of further instructions that, in response to being executed on the computing device, cause the computing device to determine the bandwidth of the workload based on a first threshold for an occupancy of the read data buffer and a second threshold for outstanding memory requests.

Example 25 includes the at least one non-transitory one machine readable medium of any of Examples 22 to 24, comprising a plurality of further instructions that, in response to being executed on the computing device, cause the computing device to deallocate prefetch entries from the read data buffer if the bandwidth of the workload is determined to exceed a bandwidth threshold.

Example 26 includes the at least one non-transitory one machine readable medium of Example 25, comprising a plurality of further instructions that, in response to being executed on the computing device, cause the computing device to deallocate prefetch entries from the read data buffer a predetermined amount of time after the bandwidth of the workload is determined to exceed the bandwidth threshold.

Example 27 includes the at least one non-transitory one machine readable medium of any of Examples 21 to 26, comprising a plurality of further instructions that, in response to being executed on the computing device, cause the computing device to store both prefetch request tracker entries and non-prefetch request tracker entries in a content-addressable memory.

Example 28 includes an apparatus, comprising means for controlling access to a memory, means for tracking both prefetch read requests and non-prefetch read requests for the memory, and means for storing both prefetch entries and non-prefetch entries in a read data buffer.

Example 29 includes the apparatus of Example 28, further comprising means for allocating prefetch entries in the read data buffer based on a bandwidth of a workload.

Example 30 includes the apparatus of Example 29, further comprising means for holding prefetch entries in the read data buffer as long as a bandwidth of the workload is determined to not exceed a bandwidth threshold and an amount of free space for the read data buffer is determined to exceed a space threshold for buffer space for non-prefetch entries.

Example 31 includes the apparatus of any of Examples 29 to 30, further comprising means for determining the bandwidth of the workload based on a first threshold for an occupancy of the read data buffer and a second threshold for outstanding memory requests.

Example 32 includes the apparatus of any of Examples 29 to 31, further comprising means for deallocating prefetch entries from the read data buffer if the bandwidth of the workload is determined to exceed a bandwidth threshold.

Example 33 includes the apparatus of Example 32, further comprising means for deallocating prefetch entries from the read data buffer a predetermined amount of time after the bandwidth of the workload is determined to exceed the bandwidth threshold.

Example 34 includes the apparatus of any of Examples 28 to 33, further comprising means for storing both prefetch request tracker entries and non-prefetch request tracker entries in a content-addressable memory.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B, or C” both may mean A; B; C; A and B; A and C; B and C; or A, B and C. Various components of the systems described herein may be implemented in software, firmware, and/or hardware and/or any combination thereof. For example, various components of the systems or devices discussed herein may be provided, at least in part, by hardware of a computing SoC such as may be found in a computing system such as, for example, a smart phone. Those skilled in the art may recognize that systems described herein may include additional components that have not been depicted in the corresponding figures. For example, the systems discussed herein may include additional components such as bit stream multiplexer or de-multiplexer modules and the like that have not been depicted in the interest of clarity.

While implementation of the example processes discussed herein may include the undertaking of all operations shown in the order illustrated, the present disclosure is not limited in this regard and, in various examples, implementation of the example processes herein may include only a subset of the operations shown, operations performed in a different order than illustrated, or additional operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as IP cores may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

It will be recognized that the embodiments are not limited to the embodiments so described, but can be practiced with modification and alteration without departing from the scope of the appended claims. For example, the above embodiments may include specific combination of features. However, the above embodiments are not limited in this regard and, in various implementations, the above embodiments may include the undertaking only a subset of such features, undertaking a different order of such features, undertaking a different combination of such features, and/or undertaking additional features than those features explicitly listed. The scope of the embodiments should, therefore, be determined with reference to the appended claims, along with the full scope of equivalents to which such claims are entitled.

What is claimed is:

1. An electronic apparatus, comprising:
one or more substrates; and
a controller coupled to the one or more substrates, the controller including:
a read data buffer,
a content-addressable memory, and
circuitry to track both prefetch read requests and non-prefetch read requests for a memory with the content-addressable memory and to store both prefetch entries and non-prefetch entries in the read data buffer.

2. The apparatus of claim 1, wherein the circuitry is further to:
allocate prefetch entries in the read data buffer based on a bandwidth of a workload.

3. The apparatus of claim 2, wherein the circuitry is further to:
hold prefetch entries in the read data buffer as long as a bandwidth of the workload is determined to not exceed a bandwidth threshold and an amount of free space for the read data buffer is determined to exceed a space threshold for buffer space for non-prefetch entries.

4. The apparatus of claim 2, wherein the circuitry is further to:
determine the bandwidth of the workload based on a first threshold for an occupancy of the read data buffer and a second threshold for outstanding memory requests.

5. The apparatus of claim 2, wherein the circuitry is further to:
deallocate prefetch entries from the read data buffer if the bandwidth of the workload is determined to exceed a bandwidth threshold.

6. The apparatus of claim 5, wherein the circuitry is further to:
deallocate prefetch entries from the read data buffer a predetermined amount of time after the bandwidth of the workload is determined to exceed the bandwidth threshold.

7. An electronic system, comprising:
memory; and
a controller communicatively coupled to the memory, the controller including a buffer and circuitry to:
track both prefetch read requests and non-prefetch read requests for the memory, and
store both prefetch entries and non-prefetch entries in the buffer.

8. The system of claim 7, wherein the circuitry is further to:
allocate prefetch entries in the buffer based on a bandwidth of a workload.

9. The system of claim 8, wherein the circuitry is further to:
hold prefetch entries in the buffer as long as a bandwidth of the workload is determined to not exceed a bandwidth threshold and an amount of free space for the buffer is determined to exceed a space threshold for buffer space for non-prefetch entries.

10. The system of claim 8, wherein the circuitry is further to:
determine the bandwidth of the workload based on a first threshold for an occupancy of the buffer and a second threshold for outstanding memory requests.

11. The system of claim 8, wherein the circuitry is further to:
deallocate prefetch entries from the buffer if the bandwidth of the workload is determined to exceed a bandwidth threshold.

12. The system of claim 11, wherein the circuitry is further to:
deallocate prefetch entries from the buffer a predetermined amount of time after the bandwidth of the workload is determined to exceed the bandwidth threshold.

13. The system of claim 7, wherein the circuitry is further to:
store both prefetch request tracker entries and non-prefetch request tracker entries in a content-addressable memory.

14. A method, comprising:
controlling access to a memory;
tracking both prefetch read requests and non-prefetch read requests for the memory; and
storing both prefetch entries and non-prefetch entries in a read data buffer.

15. The method of claim 14, further comprising:
allocating prefetch entries in the read data buffer based on a bandwidth of a workload.

16. The method of claim 15, further comprising:
holding prefetch entries in the read data buffer as long as a bandwidth of the workload is determined to not exceed a bandwidth threshold and an amount of free space for the read data buffer is determined to exceed a space threshold for buffer space for non-prefetch entries.

17. The method of claim 15, further comprising:
determining the bandwidth of the workload based on a first threshold for an occupancy of the read data buffer and a second threshold for outstanding memory requests.

18. The method of claim 15, further comprising:
deallocating prefetch entries from the read data buffer if the bandwidth of the workload is determined to exceed a bandwidth threshold.

19. The method of claim 18, further comprising:
deallocating prefetch entries from the read data buffer a predetermined amount of time after the bandwidth of the workload is determined to exceed the bandwidth threshold.

20. The method of claim 14, further comprising:
storing both prefetch request tracker entries and non-prefetch request tracker entries in a content-addressable memory.
